(19) United States
(12) Patent Application Publication
(10) Pub. No.: US 2012/0027246 A1
(43) Pub. Date: Feb. 2, 2012

(54) TECHNIQUE FOR COLLECTING INCOME-TAX INFORMATION

(75) Inventors: Alan Tifford, San Diego, CA (US); Jane L. Ryder, San Diego, CA (US); Carol A. Howe, San Diego, CA (US); Amir Eftekhari, San Diego, CA (US)

(73) Assignee: INTUIT INC., Mountain View, CA (US)

(21) Appl. No.: 12/845,947

(22) Filed: Jul. 29, 2010

(51) Int. Cl. G06K 9/00

(52) U.S. Cl. 382/100

(57) ABSTRACT

A technique for collecting income-tax information is described. This collection technique allows a user (such as a taxpayer) to provide income-tax information by submitting an image of a document, such as an income-tax summary or form. After receiving the image, the income-tax information is extracted from the document, and a subset of the income-tax information that is relevant to the user is determined. This subset of the income-tax information is then provided to the user for validation, and the user subsequently provides feedback about the subset of the income-tax information, such as acceptance of the subset or correction of any errors. Furthermore, after receiving the user feedback, fields in an income-tax return of the user may be populated using the subset of the income-tax information.

### BACKGROUND

The present disclosure relates to techniques for collecting income-tax information from a user.

Existing income-tax programs that facilitate income-tax preparation typically operate by collecting income-tax information either directly or indirectly from users. For example, a user may provide the income-tax information from forms (such as a W-2 form) by typing it in manually. Alternatively, the user may provide credential information (such as a user name and password) that allows the income-tax information to be downloaded from a payroll company's server. However, this indirect collection technique is not available for many users.

Manually providing income-tax information is a time-consuming and laborious process. Furthermore, because users don't know which data on a given form is relevant, they often provide all the information on the form, which results in wasted effort. In addition, manually provided income-tax information often contains errors that can cause mistakes in users' income-tax returns. However, requiring users to validate all of the data they have provided (such as all of the fields in a W-2 form) is also a time-consuming and laborious process, and the user may not detect all of the errors.

As a consequence, manual entry of income-tax information can adversely impact the user experience, and can result in mistakes in users' income-tax returns. Consequently, manual entry can reduce: customer satisfaction, customer retention, and sales of the income-tax programs.

### SUMMARY

The disclosed embodiments relate to a computer system that receives income-tax information. During operation, the computer system receives an image of a document from a user. Then, the computer system extracts income-tax information from fields in the document, and determines a subset of the income-tax information which is relevant to an income-tax return of the user based on predefined information for different types of income-tax returns. Next, the computer system provides the subset of the income-tax information to the user for validation. The computer system also receives feedback from the user about the subset of the income-tax information.

Note that the document may include a summary of the income-tax information of the user during a time interval. For example, the document may include a W-2 form. Furthermore, the image may include a photograph of the document, such as an image that is captured using an imaging device on a portable electronic device (e.g., a cellular telephone).

In some embodiments, extracting the income-tax information involves optical character recognition (OCR). Additionally, providing the subset of the income-tax information may involve providing the subset of the income-tax information in a format that is suitable for presentation on a display, such as that of the portable electronic device.

The feedback may include the user's acceptance of the subset of the income-tax information and/or a correction of an error in the subset of the income-tax information. After receiving the feedback, the computer system may populate fields in the income-tax return of the user based on the subset of the income-tax information.

Another embodiment provides a method that includes at least some of the operations performed by the computer system.

Another embodiment provides a computer-program product for use with the computer system. This computer-program product includes instructions for at least some of the operations performed by the computer system.

### BRIEF DESCRIPTION OF THE FIGURES

FIG. 1 is a flow chart illustrating a method for receiving income-tax information in accordance with an embodiment of the present disclosure.

FIG. 2 is a flow chart illustrating the method of FIG. 1 in accordance with an embodiment of the present disclosure.

FIG. 3 is a block diagram illustrating a user interface for displaying income-tax information and receiving user feedback in accordance with an embodiment of the present disclosure.

FIG. 4 is a block diagram illustrating a computer system that performs the method of FIG. 1 in accordance with an embodiment of the present disclosure.

FIG. 5 is a block diagram illustrating a computer system that performs the method of FIG. 1 in accordance with an embodiment of the present disclosure.

Table 1 provides relevance criteria for the income-tax information in the fields in a W-2 form in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

Embodiments of a computer system, a technique for receiving income-tax information, and a computer-program product (e.g., software) for use with the computer system are described. This collection technique allows a user (such as a taxpayer) to provide income-tax information by submitting an image of a document, such as an income-tax summary or form. After receiving the image, the income-tax information is extracted from the document, and a subset of the income-tax information that is relevant to the user is determined. This subset of the income-tax information is then provided to the user for validation, and the user subsequently provides feedback about the subset of the income-tax information, such as acceptance of the subset or correction of any errors. Furthermore, after receiving the user feedback, fields in an income-tax return of the user may be populated using the subset of the income-tax information.

By facilitating collection of the subset of the income-tax information, this technique may make it easier for users to accurately and efficiently complete their income-tax returns. For example, the users may only have to validate the subset of the income-tax information (as opposed to all of the income-tax information). When included in income-tax software, this capability may: reduce mistakes in income-tax returns, increase sales, improve customer satisfaction and/or increase customer retention.

In the discussion that follows, the users may include a variety of entities, such as: an individual, an organization, a business and/or a government agency. Furthermore, a ‘business’ should be understood to include: for-profit corporations, non-profit corporations, organizations, groups of individuals, sole proprietors, government agencies, partnerships, limited liability corporations, etc.

Note that in the discussion that follows an image of a document is used to submit or provide the income-tax information. However, in other embodiments the income-tax information can be provided using a wide variety of formats and techniques, including: user-entered text or alpha-numeric characters, voice, video and/or data in a computer-readable electronic format (such as an electronic data stream).

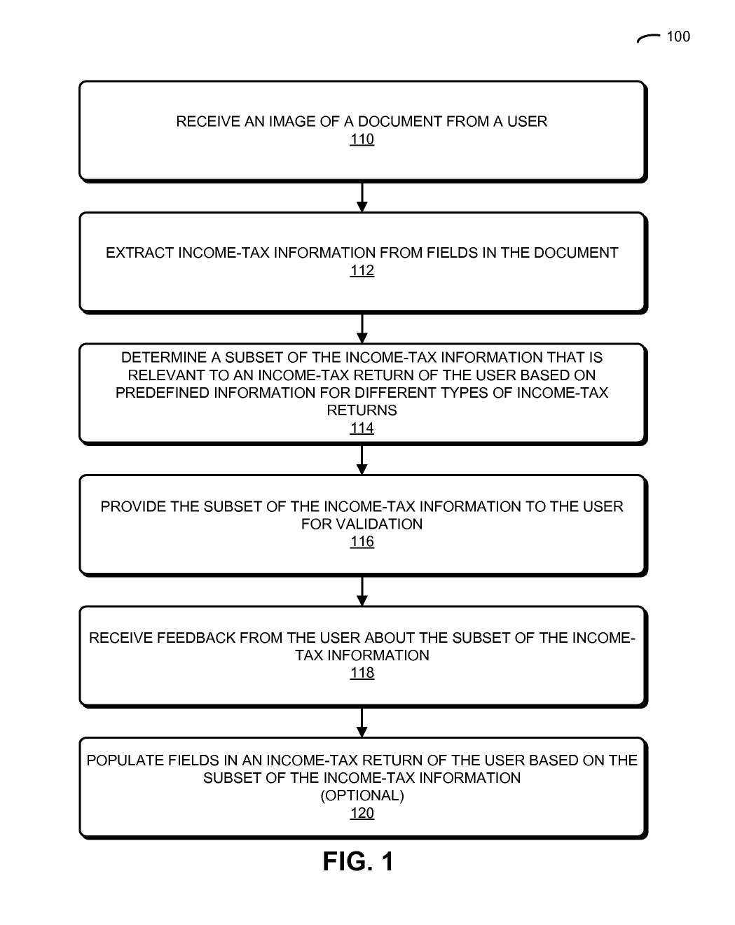

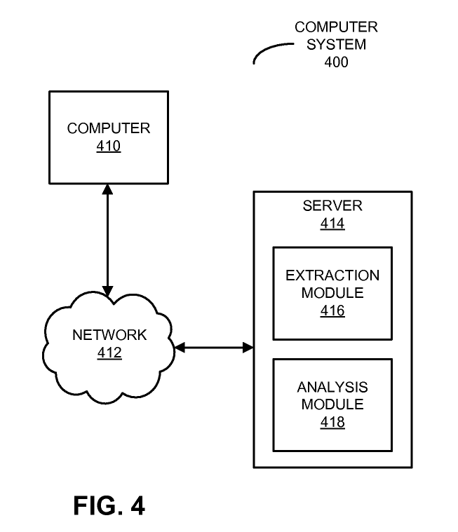

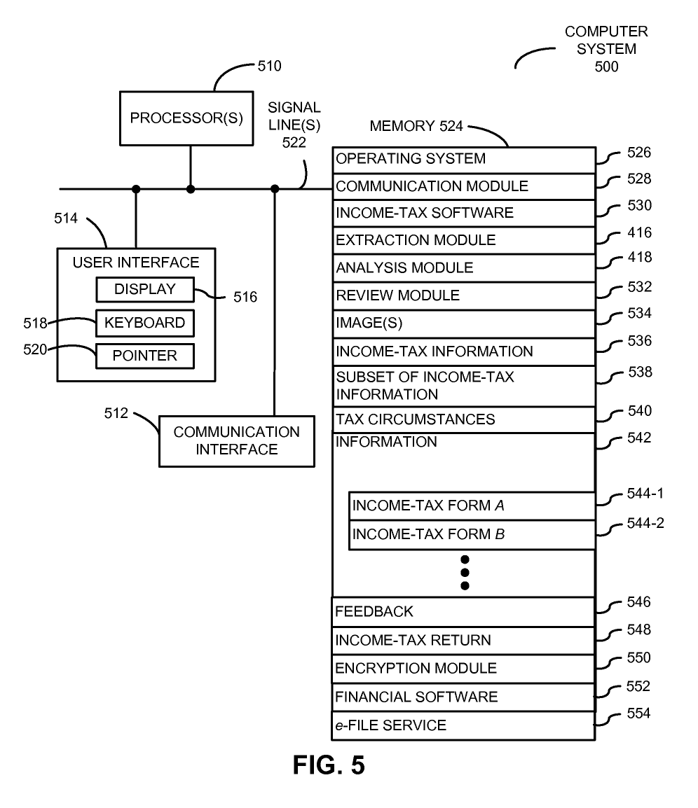

We now describe embodiments of the collection technique. FIG. 1 presents a flow chart illustrating a method 100 for receiving income-tax information, which may be performed by a computer system (such as computer systems 400 in FIG. 4 and/or 500 in FIG. 5). During operation, the computer system receives an image of a document from a user (operation 110). This document may include a summary of the income-tax information of the user during a time interval (such as a quarter or a year). For example, the document may include a W-2 form. Furthermore, the image may include a photograph of the document, such as an image that is captured using an imaging device (such as a camera) on a portable electronic device (e.g., a cellular telephone).

Then, the computer system extracts income-tax information from fields in the document (operation 112), and determines a subset of the income-tax information which is relevant to an income-tax return of the user based on predefined information for different types of income-tax returns (operation 114).

For example, extracting the income-tax information may involve optical character recognition (OCR).

Next, the computer system provides the subset of the income-tax information to the user for validation (operation 116), and receives feedback from the user about the subset of the income-tax information (operation 118). Note that providing the subset of the income-tax information may involve providing the subset of the income-tax information in a format that is suitable for presentation on a display, such as that of the portable electronic device. Furthermore, the feedback may include the user's acceptance of the subset of the income-tax information and/or a correction of one or more errors in the subset of the income-tax information.

After receiving the feedback, the computer system may optionally populate fields in the income-tax return of the user based on the subset of the income-tax information (operation 120).

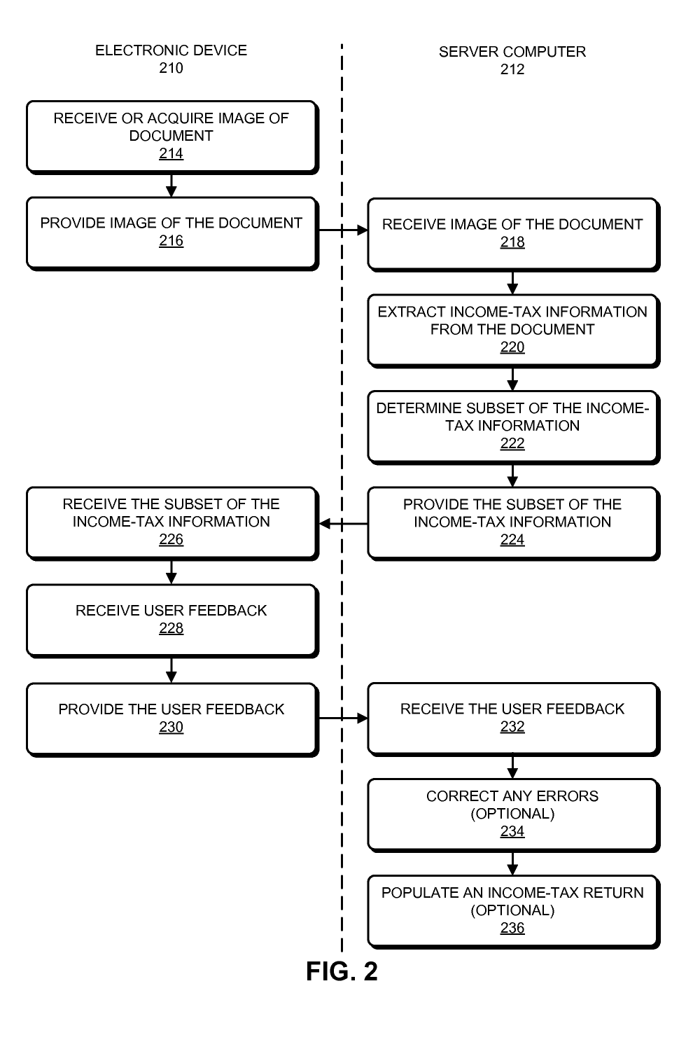

In an exemplary embodiment, the collection technique is implemented using an electronic device (such as a client computer or the portable electronic device) and at least one server computer, which communicate through a network, such as the Internet (i.e., using a client-server architecture). This is illustrated in FIG. 2, which presents a flow chart illustrating method 100. During this method, electronic device 210 receives the image of the document from the user or acquires the image of the document (operation 214). Then, electronic device 210 provides the image of the document (operation 216) to server computer 212. After receiving the image (operation 218), server computer 212 extracts the income-tax information from fields in the document (operation 220), and determines the subset of the income-tax information relevant to the income-tax return of the user based on predefined information for different types of income-tax returns (operation 222).

Next, server computer 212 provides the subset of the income-tax information to electronic device 210 for validation (operation 224). After electronic device 210 receives the subset of the income-tax information (operation 226), the user provides feedback to electronic device 210 (operation 228). This feedback is, in turn, provided by electronic device 210 to server computer 212 (operation 230).

After receiving the feedback (operation 232), server computer 212 may optionally correct any identified errors in the subset of the income-tax information (operation 234) and/or may optionally populate fields in the income-tax return of the user based on the subset of the income-tax information (operation 236).

In some embodiments of method 100 (FIGS. 1 and 2), there may be additional or fewer operations. Moreover, the order of the operations may be changed, and/or two or more operations may be combined into a single operation.

In an exemplary embodiment, a user uploads a picture or a scanned image of an income-tax document (such as a W-2 form or, more generally, any income-tax-related document) to a computer or a server that is operated by a provider of the income-tax software. However, in some embodiments the user provides the original document to the provider of the income-tax software, and the information in this document is subsequently scanned in. After receiving the image, the income-tax information in the income-tax document is obtained, for example by using an OCR engine (such as FlexiCapture OCR software from ABBYY Software House, Inc. of Moscow, Russia).

Furthermore, the user's tax situation or circumstance is assessed based on the income-tax information and/or based on answers to questions from the income-tax program that are provided by the user (such as the user's income level, etc.) so that the user can be assigned to a particular income-tax category or type of income-tax return (including the associated income-tax return forms). For example, the user may be a simple income-tax filer who will use the 1040EZ form, if: the user's income level is currently less than $80,000 for single filers (or $100,000 for married filers) so that they most likely will not be itemizing their deductions; and/or they did not hit the Social Security tax limit ($105,000 in 2009) or the sum of individual local/state tax limits (such as the current $90,669 State Disability Insurance limit in California).

Based on this classification, an income-tax analysis engine determines a subset of the income-tax information in the income-tax document that is relevant to the user's income-tax return (and the 1040EZ form). For example, Table 1 summarizes relevance criteria for the income-tax information in the fields in a W-2 form for a general tax return (including that for the 1040EZ) form for a particular user (who has a given income level and demographic group) based on current income-tax law. In particular, Table 1 delineates the fields in the W-2 form that are: required, conditionally required, or not required at all for accurate and compliant income-tax calculations. Note that validation of some fields may be required if they are read using OCR, such as: Box 7, Box 8, Box 9, Box 10, Box 11, Boxes 12a-12d and Box 14.

TABLE 1

| W-2 Field | Relevance | Condition(s) |
|---|---|---|
| Title and year | Conditionally required | If the user did not identify |
| information | | the income-tax document |
| a) Social Security | Not required | Can be entered using other |
| Number | | techniques |
| b) Employer | Conditionally required | If e-file |
| Identification | | |
| Number | | |
| c) Employer's Name | Conditionally required | If e-file |
| and Address | | |
| d) Control Number | Not required | N/A |
| Department | Not required | N/A |
| Corporation | Not required | N/A |
| Employer use only | Not required | N/A |
| e/f) Employee's | Not required | Can be entered using other |
| name and address | | techniques |
| Box 1 | Required | N/A |
| Box 2 | Conditionally required | If data present |
| Box 3 | Conditionally required | If user's total W-2 Box 3 |
| | | amount exceeds the Social |
| | | Security wage limit |
| Box 4 | Conditionally required | If user's total W-2 Box 3 |
| | | amount exceeds the Social |
| | | Security wage limit |
| Box 5 | Conditionally required | N/A |
| Box 6 | Conditionally required | N/A |
| Box 7 | Conditionally required | If data present |
| Box 8 | Conditionally required | If data present |
| Box 9 | Conditionally required | If data present |
| Box 10 | Conditionally required | If data present |
| Box 11 | Conditionally required | If data present |
| Boxes 12a-12d | Conditionally required | If data present |
| Box 13 | Conditionally required | If data present |
| Box 14 | Conditionally required | If relevant data (e.g., |
| | | California State Disability |
| | | Insurance is deductible) |
| Box 15 (2 letter | Conditionally required | Box 17 has a value |
| state code) | | |
| Box 15 (employer | Conditionally required | If state identifier is present, |
| state identification | | the state has income tax, |
| number) | | and if e-file |
| Box 16 | Conditionally required | If Box 15 has more than |
| | | one state or Box 16 is not |
| | | equal to Box 1 |
| Box 17 | Conditionally required | If data present |
| Box 18 | Conditionally required | If data is present and a local |
| | | tax return is required |
| Box 19 | Conditionally required | If data is present and the |
| | | user is itemizing or has |
| | | exceeded local/state tax |
| | | limit per local/state tax |
| | | description in Box 20 or a |
| | | local tax return is required |
| Box 20 | Conditionally required | If Box 19 meets its |
| | | requirement conditions |

The income-tax analysis engine may then present the subset of the income-tax information to the user for review. In this way, the user is not forced to evaluate all the fields in the W-2 form, which: reduces the review time and effort, simplifies the overall process (because the user no longer has to understand which fields are important for their income-tax return), and focuses the user's attention on the relevant income-tax information (which may increase the likelihood that the user identifies any errors that occurred during processing, such as during the OCR). After reviewing the subset of the income-tax information, the user can provide feedback, such as validation (i.e., that the subset of the income-tax information is correct) and/or correction of any errors.

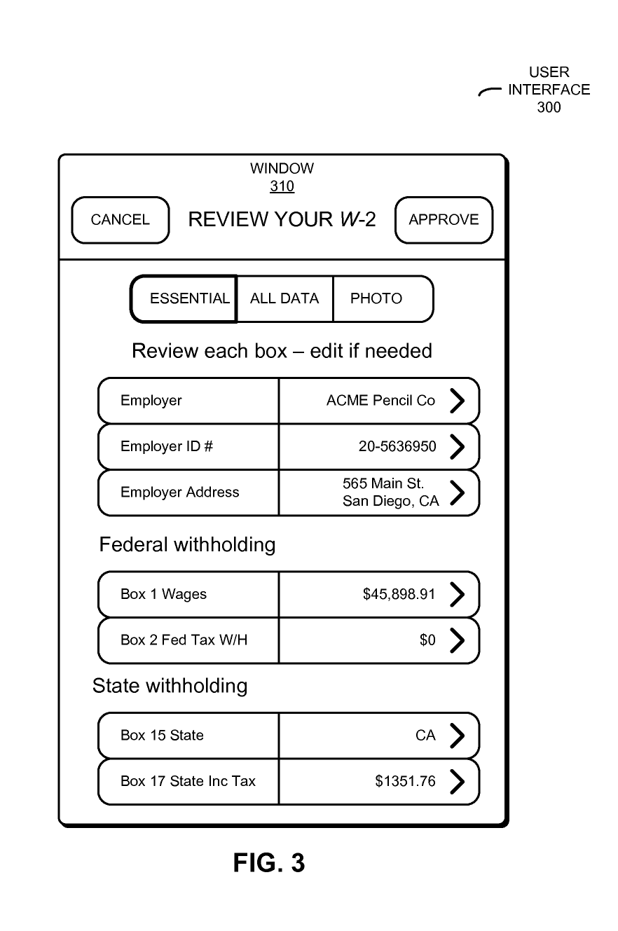

In some embodiments, the user provides the picture of the income-tax return using a camera in a cellular telephone. In addition, the subset of the income-tax information may be presented to the user for review using a user interface that is displayed on the cellular telephone (and, more generally, on a display on an electronic device, such as a computer). This is shown in FIG. 3, which presents a block diagram illustrating a user interface 300 for displaying income-tax information and receiving user feedback. In particular, the user interface may include a window 310 that allows the user to view the relevant data (i.e., the subset of the income-tax information) when the ‘essential’ icon is activated, or all of the data (i.e., the income-tax information) when the ‘all data’ icon is activated. As noted previously, this division may make it easier for the user to understand which of the fields are important (and which are less important). Furthermore, feedback may be provided by correcting any error (by activating the ‘arrow’ icons to the right of the displayed information, which will allow the values to be edited) and/or by validating the displayed information (by activating the ‘approve’ icon).

We now describe embodiments of the computer system and its use. FIG. 4 presents a block diagram illustrating a computer system 400 that performs method 100 (FIGS. 1 and 2). In this system, a user of computer 410 (and, more generally, an electronic device) may use income-tax software to prepare an income-tax return. This income-tax software may be a stand-alone application or a portion of another application that is resident on and which executes on computer 410 (such as financial software that is provided by server 414 or that is installed and which executes on computer 410).

In some embodiments, at least a portion of the income-tax software may be an application tool (such as an income-tax application tool) that is embedded in the web page (and which executes in a virtual environment of the web browser). In an illustrative embodiment, the income-tax application tool is a software package written in: JavaScript™ (a trademark of Oracle Corporation), e.g., the income-tax application tool includes programs or procedures containing JavaScript instructions, ECMAScript (the specification for which is published by the European Computer Manufacturers Association International), VBScript™ (a trademark of Microsoft Corporation) or any other client-side scripting language.

In other words, the embedded income-tax application tool may include programs or procedures containing: JavaScript, ECMAScript instructions, VBScript instructions, or instructions in another programming language suitable for rendering by the web browser or another client application (such as on computer 410). Thus, the income-tax application tool may be provided to the user via a client-server architecture.

As discussed previously, the user may provide an image of the income-tax document to server 414 via network 412, for example, the user may upload a picture of the income-tax document from computer 410. Then, an extraction engine or module 416 (such as an OCR engine) may extract the income-tax information from the image, and an analysis engine or module 418 may determine the subset of the income-tax information based on: the user's tax circumstances, predefined information for the associated income-tax return forms (which are associated with different types of income-tax returns), and/or the income-tax information in the income-tax document. Next, server 414 may provide the subset of the income-tax information back to the computer 410 via network 412 for review and either validation or correction by the user. Once the subset of the income-tax information has been validated, it may be used to populate fields in an income-tax return of the user.

Note that the information in computer system 400 (such as the information about the user's tax circumstances and the predefined information for the income-tax return forms) may be stored at one or more locations in computer system 400 (i.e., locally or remotely). Moreover, because this information may be sensitive in nature, it may be encrypted. For example, stored information and/or information communicated via network 412 may be encrypted.

FIG. 5 presents a block diagram illustrating a computer system 500 that performs method 100 (FIGS. 1 and 2), such as server 414 (FIG. 4). Computer system 500 includes one or more processing units or processors 510, a communication interface 512, a user interface 514, and one or more signal lines 522 coupling these components together. Note that the one or more processors 510 may support parallel processing and/or multi-threaded operation, the communication interface 512 may have a persistent communication connection, and the one or more signal lines 522 may constitute a communication bus. Moreover, the user interface 514 may include: a display 516 (such as a touch-sensitive display), a keyboard 518, and/or a pointer 520, such as a mouse.

Memory 524 in computer system 500 may include volatile memory and/or non-volatile memory. More specifically, memory 524 may include: ROM, RAM, EPROM, EEPROM, flash memory, one or more smart cards, one or more magnetic disc storage devices, and/or one or more optical storage devices. Memory 524 may store an operating system 526 that includes procedures (or a set of instructions) for handling various basic system services for performing hardware-dependent tasks. Memory 524 may also store procedures (or a set of instructions) in a communication module 528. These communication procedures may be used for communicating with one or more computers and/or servers, including computers and/or servers that are remotely located with respect to computer system 500.

Memory 524 may also include multiple program modules (or sets of instructions), including: income-tax software 530 (or a set of instructions), extraction module 416 (or a set of instructions), analysis module 418 (or a set of instructions), review module 532 (or a set of instructions), encryption module 550 (or a set of instructions), financial software 552 (or a set of instructions) and/or e-file service 554 (or a set of instructions). Note that one or more of these program modules (or sets of instructions) may constitute a computer-program mechanism.

During method 100 (FIG. 1), the user may provide one or more images 534 of one or more income-tax documents. Income-tax information 536 in the income-tax document may be extracted from one or more of images 534 using extraction module 416 (such as by using an OCR engine). Then, analysis module 418 may determine subset of the income-tax information 538 based on income-tax information 536, the user's tax circumstances 540 and/or predefined information 542 associated with fields in different income-tax forms (including those associated with the user's income-tax return 548). For example, predefined information 542 may include that associated with income-tax form A 544-1 and income-tax form B 544-2.

Next, review module 532 may communicate subset of the income-tax information 538 to the user for review. In response, the user may provide feedback 546, such as validation of subset of the income-tax information 538 and/or correction of any identified errors. After validation and/or correction of any errors, subset of the income-tax information 538 may be used to populate fields in the user's income-tax return 548. In some embodiments, e-file service 554 subsequently files the user's income-tax return 548 after it is completed by the user.

Furthermore, because the information about the user's income-tax information may be sensitive in nature, in some embodiments at least some of the information stored in memory 524 and/or at least some of the information communicated using communication module 528 is encrypted using encryption module 550. Additionally, in some embodiments one or more of the modules in memory 524 may be included in financial software 552.

Instructions in the various modules in memory 524 may be implemented in: a high-level procedural language, an object-oriented programming language, and/or in an assembly or machine language. Note that the programming language may be compiled or interpreted, e.g., configurable or configured, to be executed by the one or more processors 510.

Although computer system 500 is illustrated as having a number of discrete items, FIG. 5 is intended to be a functional description of the various features that may be present in computer system 500 rather than a structural schematic of the embodiments described herein. In practice, and as recognized by those of ordinary skill in the art, the functions of computer system 500 may be distributed over a large number of servers or computers, with various groups of the servers or computers performing particular subsets of the functions. In some embodiments, some or all of the functionality of computer system 500 may be implemented in one or more application-specific integrated circuits (ASICs) and/or one or more digital signal processors (DSPs).

Computers and servers in computer systems 400 (FIG. 4) and/or 500 may include one of a variety of devices capable of manipulating computer-readable data or communicating such data between two or more computing systems over a network, including: a personal computer, a laptop computer, a mainframe computer, a portable electronic device (such as a cellular phone or PDA), a server and/or a client computer (in a client-server architecture). Moreover, network 412 (FIG. 4) may include: the Internet, World Wide Web (WWW), an intranet, LAN, WAN, MAN, or a combination of networks, or other technology enabling communication between computing systems.

In exemplary embodiments, the financial-software application (i.e., financial software 552) includes: Quicken™ and/or TurboTax™ (from Intuit, Inc., of Mountain View, Calif.), Microsoft Money™ (from Microsoft Corporation, of Redmond, Wash.), SplashMoney™ (from SplashData, Inc., of Los Gatos, Calif.), Mvelopes™ (from In2M, Inc., of Draper, Utah), and/or open-source applications such as Gnucash™, PLCash™, Budget™ (from Snowmint Creative Solutions, LLC, of St. Paul, Minn.), and/or other planning software capable of processing financial information.

Moreover, the financial-software application may include software such as: QuickBooks™ (from Intuit, Inc., of Mountain View, Calif.), Peachtree™ (from The Sage Group PLC, of Newcastle Upon Tyne, the United Kingdom), Peachtree Complete™ (from The Sage Group PLC, of Newcastle Upon Tyne, the United Kingdom), MYOB Business Essentials™ (from MYOB US, Inc., of Rockaway, N.J.), NetSuite Small Business Accounting™ (from NetSuite, Inc., of San Mateo, Calif.), Cougar Mountain™ (from Cougar Mountain Software, of Boise, Id.), Microsoft Office Accounting™ (from Microsoft Corporation, of Redmond, Wash.), Simply Accounting™ (from The Sage Group PLC, of Newcastle Upon Tyne, the United Kingdom), CYMA IV Accounting™ (from CYMA Systems, Inc., of Tempe, Ariz.), DacEasy™ (from Sage Software SB, Inc., of Lawrenceville, Ga.), Microsoft Money™ (from Microsoft Corporation, of Redmond, Wash.), Tally.ERP (from Tally Solutions, Ltd., of Bangalore, India) and/or other payroll or accounting software capable of processing payroll information.

User interface 300 (FIG. 3), computer system 400 (FIG. 4), and/or computer system 500 may include fewer components or additional components. Moreover, two or more components may be combined into a single component, and/or a position of one or more components may be changed. In some embodiments, the functionality of computer systems 400 (FIG. 4) and/or 500 may be implemented more in hardware and less in software, or less in hardware and more in software, as is known in the art.

While the preceding embodiments illustrate the use of the collection technique with income-tax information (and, more generally, financial information), this technique may be used with a wide variety of information in a diverse group of applications (and associated forms), including: loan information for use in a loan form, insurance information for use in an insurance form, immigration information for use in an immigration form, etc. Thus, if information for use in a form is extracted using OCR or an automated-data-input technique, knowledge about predefined information in this form (such as the format of the form) and/or the circumstances of a given user may be used restrict or limit the amount of information that is subsequently verified by this user.

The foregoing description is intended to enable any person skilled in the art to make and use the disclosure, and is provided in the context of a I-cular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. A computer-implemented method for receiving income-tax information, comprising:
receiving an image of a document from a user;
extracting, using a computer, income-tax information from fields in the document;
determining a subset of the income-tax information relevant to an income-tax return of the user based on predefined information for different types of income-tax returns;
providing the subset of the income-tax information to the user for validation; and
receiving feedback from the user about the subset of the income-tax information.

2. The method of claim 1, wherein the document includes a W-2 form.

3. The method of claim 1, wherein the document includes a summary of the income-tax information of the user during a time interval.

4. The method of claim 1, wherein extracting the income-tax information involves optical character recognition (OCR).

5. The method of claim 1, wherein providing the subset of the income-tax information involves providing the subset of the income-tax information in a format that is suitable for presentation on a display.

6. The method of claim 1, wherein the image includes a photograph of the document.

7. The method of claim 1, wherein the image is associated with an imaging device on a portable electronic device.

8. The method of claim 1, wherein the feedback includes user acceptance of the subset of the income-tax information.

9. The method of claim 1, wherein the feedback includes a correction of an error in the subset of the income-tax information.

10. The method of claim 1, wherein, after receiving the feedback, the method further includes populating fields in the income-tax return of the user based on the subset of the income-tax information.

11. A non-transitory computer-program product for use in conjunction with a computer system, the computer-program product comprising a computer-readable storage medium and a computer-program mechanism embedded therein to receive income-tax information, the computer-program mechanism including:
instructions for receiving an image of a document from a user;
instructions for extracting income-tax information from fields in the document;
instructions for determining a subset of the income-tax information relevant to an income-tax return of the user based on predefined information for different types of income-tax returns;
instructions for providing the subset of the income-tax information to the user for validation; and
instructions for receiving feedback from the user about the subset of the income-tax information.

12. The computer-program product of claim 11, wherein the document includes a W-2 form.

13. The computer-program product of claim 11, wherein extracting the income-tax information involves optical character recognition (OCR).

14. The computer-program product of claim 11, wherein providing the subset of the income-tax information involves providing the subset of the income-tax information in a format that is suitable for presentation on a display.

15. The computer-program product of claim 11, wherein the image includes a photograph of the document.

16. The computer-program product of claim 11, wherein the image is associated with an imaging device on a portable electronic device.

17. The computer-program product of claim 11, wherein the feedback includes user acceptance of the subset of the income-tax information.

18. The computer-program product of claim 11, wherein the feedback includes user correction of an error in the subset of the income-tax information.

19. The computer-program product of claim 11, wherein the computer-program mechanism includes instructions for populating fields in the income-tax return of the user based on the subset of the income-tax information after receiving the feedback.

20. A computer system, comprising:
a processor;
memory; and
a program module, wherein the program module is stored in the memory and configurable to be executed by the processor to receive income-tax information, the program module including:
instructions for receiving an image of a document from a user;
instructions for extracting income-tax information from fields in the document;
instructions for determining a subset of the income-tax information relevant to an income-tax return of the user based on predefined information for different types of income-tax returns;
instructions for providing the subset of the income-tax information to the user for validation; and
instructions for receiving feedback from the user about the subset of the income-tax information.
